(19) United States
(12) Patent Application Publication
(10) Pub. No.: US 2018/0184380 A1
(43) Pub. Date: Jun. 28, 2018

(54) LOW ENERGY WIRELESS NETWORK APPLICATIONS

(71) Applicant: QUALCOMM Incorporated, San Diego, CA (US)

(72) Inventor: Qi Xue, San Diego, CA (US)

(21) Appl. No.: 15/901,594

(22) Filed: Feb. 21, 2018

Related U.S. Application Data
(62) Division of application No. 15/164,668, filed on May 25, 2016.
(60) Provisional application No. 62/167,170, filed on May 27, 2015.
(60) Provisional application No. 62/167,183, filed on May 27, 2015.

(51) Int. Cl. H04W 52/02; H04W 4/80; H04W 72/12; H04W 84/12; H04W 88/06; H04W 88/10

(52) U.S. Cl. CPC H04W 52/0251; H04W 52/0206; H04W 4/80; H04W 72/1247; Y02D 70/00; H04W 88/10; Y02D 70/22; Y02D 70/144; H04W 84/12; H04W 88/06; Y02D 70/142

(57) ABSTRACT

A method for enabling access point discovery in a wireless network includes scanning, at an access point, a low energy protocol advertising channel for beacon information broadcasted from a second access point. The low energy protocol advertising channel is associated with a low energy protocol that is different from a first protocol associated with a primary operating channel of the access point. The method further includes receiving the beacon information at the access point via the low energy protocol advertising channel.

### I. CROSS-REFERENCE TO RELATED APPLICATIONS

The present application is a divisional application of and claims priority from U.S. patent application Ser. No. 15/164,668, filed May 25, 2016, entitled “LOW ENERGY WIRELESS NETWORK APPLICATIONS”, which claims priority from U.S. Provisional Patent Application No. 62/167,170, filed May 27, 2015, entitled “LOW ENERGY POWER MANAGEMENT FOR A WIRELESS NETWORK”, and U.S. Provisional Patent Application No. 62/167,183, filed May 27, 2015, entitled “LOW ENERGY ACCESS POINT DISCOVERY”, the contents of each of which are incorporated by reference in their entirety.

### II. FIELD

The present disclosure is generally related to power management for a wireless network and access point discovery in the wireless network.

### III. DESCRIPTION OF RELATED ART

Stations (e.g., wireless telephones) in a wireless network may operate in two power modes. For example, a station in an Institute of Electrical and Electronics Engineers (IEEE) 802.11 (e.g., “Wi-Fi”) wireless network may operate in an “awake” mode (e.g., a fully powered mode of operation) and in a “sleep” mode. During operation in the awake mode, the station may be able to transmit data to (and receive data from) an access point in the IEEE 802.11 wireless network. During operation in the sleep mode, the radio frequency capabilities of the station may be significantly reduced to conserve power and the station may not able to transmit data to (or receive data from) the access point.

When the station is in the sleep mode, the access point may buffer downlink data designated for the station and may indicate to the station that pending downlink data is available. For example, the access point may transmit a beacon to the station approximately every 100 milliseconds (ms). The beacon may include a traffic indication map indicating that pending downlink data is available. The station may “wake up” (e.g., enter the awake mode) periodically (e.g., once approximately every 100 ms) to receive the traffic indication map in the beacon and to check for pending downlink data. If the traffic indication map indicates that there is pending downlink data available, the station may communicate with the access point to receive the pending downlink data. If the traffic indication map indicates that there is no pending downlink data available, the station may reenter the sleep mode. Periodically waking up to receive the traffic indication map may reduce battery life at the station (e.g., due to overhead involved in repeatedly powering up and powering down radio frequency communication circuitry at the station). However, failing to periodically wake up to receive the traffic indication map may increase application delay. For example, large amounts of pending downlink data may be buffered at the access point.

Additionally, in order to receive nearby access point information from a Wi-Fi access point in a Wi-Fi network, a station (e.g., a wireless telephone) may scan a randomly selected Wi-Fi channel for access point information (e.g., a beacon, a neighbor report, etc.). However, if a Wi-Fi access point is not operating on the randomly selected Wi-Fi channel, the station may have to scan another Wi-Fi channel to receive the access point information. Scanning multiple Wi-Fi channels for access point information may increase the amount of time for establishing a link with a “preferred” access point. For example, an access points in a Wi-Fi network may operate in a 2.4 Gigahertz (GHz) frequency band or a 5 GHz frequency band. The 2.4 GHz frequency band may include 3 non-overlapping Wi-Fi channels, and the 5 GHz frequency band may include 23 non-overlapping Wi-Fi channels. Thus, in some instances, the station may scan up to 26 Wi-Fi channels prior to receiving access point information from a Wi-Fi access point. Scanning multiple Wi-Fi channels increases an initial link setup time.

### IV. SUMMARY

According to one example of the techniques disclosed herein, a method for managing power in a wireless network includes generating beacon information at an access point of the wireless network. The access point is configured to communicate downlink data to a station of the wireless network according to a first protocol. The method also includes sending (e.g., broadcasting) the beacon information to the station while the station is in a sleep mode according to a low energy protocol that is different from the first protocol. In particular examples, the first protocol is an IEEE 802.11 protocol and the low energy protocol is a BLE protocol or an IEEE 802.11ah protocol.

According to another example of the techniques disclosed herein, an apparatus includes a process and a memory storing instructions that are executable by the processor to perform operations. The operations include generating beacon information at an access point of a wireless network. The access point is configured to communicate downlink data to a station of the wireless network according to a first protocol. The operations also include sending (e.g., broadcasting) the entire beacon information or part of the beacon information to the station while the station is in a sleep mode according to a low energy protocol that is different from the first protocol.

According to another example of the techniques disclosed herein, a non-transitory computer-readable medium includes instructions for managing power in a wireless network. The instructions, when executed by a processor, cause the processor to perform operations. The operations include generating beacon information at an access point of the wireless network. The access point is configured to communicate downlink data to a station of the wireless network according to a first protocol. The operations also include sending (e.g., broadcasting) the beacon information to the station while the station is in a sleep mode according to a low energy protocol that is different from the first protocol.

According to another example of the techniques disclosed herein, an apparatus includes means for generating beacon information at an access point of a wireless network. The access point is configured to communicate downlink data to a station of the wireless network according to a first protocol. The apparatus also includes means for sending (e.g., broadcasting) the beacon information to the station while the station is in a sleep mode according to a low energy protocol that is different from the first protocol.

According to another example of the techniques disclosed herein, a method for managing power in a wireless network includes receiving beacon information at a station of the wireless network from an access point of the wireless network. The beacon information is received according to a low energy protocol while the station is in a sleep mode. The method also includes entering into an awake mode to communicate with the access point based on the beacon information according to a first protocol that is different from the low energy protocol.

According to another example of the techniques disclosed herein, an apparatus includes a process and a memory storing instructions that are executable by the processor to perform operations. The operations include receiving beacon information at a station of a wireless network from an access point of the wireless network. The beacon information is received according to a low energy protocol while the station is in a sleep mode. The operations also include entering into an awake mode to communicate with the access point based on the beacon information according to a first protocol that is different from the low energy protocol.

According to another example of the techniques disclosed herein, a non-transitory computer-readable medium includes instructions for managing power in a wireless network. The instructions, when executed by a processor, cause the processor to perform operations. The operations include receiving beacon information at a station of the wireless network from an access point of the wireless network. The beacon information is received according to a low energy protocol while the station is in a sleep mode. The operations also include entering into an awake mode to communicate with the access point based on the beacon information according to a first protocol that is different from the low energy protocol.

According to another example of the techniques disclosed herein, an apparatus includes means for receiving beacon information at a station of a wireless network from an access point of the wireless network. The beacon information is received according to a low energy protocol while the station is in a sleep mode. The apparatus also includes means for entering into an awake mode to communicate with the access point based on the beacon information according to a first protocol that is different from the low energy protocol.

According to another example of the techniques disclosed herein, a method for enabling access point discovery in a wireless network includes generating beacon information at an access point configured to communicate data via the wireless network using a first protocol. The beacon information is associated with operation of the access point according to the first protocol. The method also includes broadcasting the beacon information to at least one other device according to a low energy protocol. The low energy protocol is different from the first protocol.

According to another example of the techniques disclosed herein, an apparatus includes a processor and a memory storing instructions that are executable by the processor to perform operations. The operations include generating beacon information at an access point configured to communicate data via a wireless network using a first protocol. The beacon information is associated with operation of the access point according to the first protocol. The operations also include broadcasting the beacon information to at least one other device according to a low energy protocol. The low energy protocol is different from the first protocol.

According to another example of the techniques disclosed herein, a non-transitory computer-readable medium includes instructions for enabling access point discovery in a wireless network. The instructions, when executed by a processor, cause the processor to perform operations. The operations include generating beacon information at an access point configured to communicate data via the wireless network using a first protocol. The beacon information is associated with operation of the access point according to the first protocol. The operations also include broadcasting the beacon information to at least one other device according to a low energy protocol. The low energy protocol is different from the first protocol.

According to another example of the techniques disclosed herein, an apparatus includes means for generating beacon information at an access point configured to communicate data via a wireless network using a first protocol. The beacon information is associated with operation of the access point according to the first protocol. The apparatus also includes means for broadcasting the beacon information to at least one other device according to a low energy protocol. The low energy protocol is different from the first protocol.

According to another example of the techniques disclosed herein, a method for enabling access point discovery in a wireless network includes scanning, at an access point, a low energy protocol advertising channel for beacon information broadcasted from a second access point. The low energy protocol advertising channel is associated with a low energy protocol that is different from a first protocol associated with a primary operating channel of the access point.

According to another example of the techniques disclosed herein, an apparatus includes a processor and a memory storing instructions that are executable by the processor to perform operations. The operations include scanning, at an access point, a low energy protocol advertising channel for beacon information broadcasted from a second access point. The low energy protocol advertising channel is associated with a low energy protocol that is different from a first protocol associated with a primary operating channel of the access point.

According to another example of the techniques disclosed herein, a non-transitory computer-readable medium includes instructions for enabling access point discovery in a wireless network. The instructions, when executed by a processor, cause the processor to perform operations. The operations include scanning, at an access point, a low energy protocol advertising channel for beacon information broadcasted from a second access point. The low energy protocol advertising channel is associated with a low energy protocol that is different from a first protocol associated with a primary operating channel of the access point.

According to another example of the techniques disclosed herein, an apparatus includes means for scanning a low energy protocol advertising channel for beacon information at an access point. The beacon information is broadcasted from a second access point, and the low energy protocol advertising channel is associated with a low energy protocol that is different from a first protocol associated with a primary operating channel of the access point. The apparatus also includes means for changing the primary operating channel of the access point to a different channel based on the beacon information.

According to another example of the techniques disclosed herein, a method for enabling access point discovery in a wireless network includes scanning, at a station, a low energy protocol advertising channel for beacon information broadcasted from an access point. The beacon information is associated with operation of the access point according to a first protocol. The low energy protocol advertising channel is associated with a low energy protocol that is different from the first protocol. The first protocol is associated with a primary operating channel of the access point.

According to another example of the techniques disclosed herein, an apparatus includes a processor and a memory storing instructions that are executable by the processor to perform operations. The operations include scanning, at a station, a low energy protocol advertising channel for beacon information broadcasted from an access point. The beacon information is associated with operation of the access point according to a first protocol. The low energy protocol advertising channel is associated with a low energy protocol that is different from the first protocol. The first protocol is associated with a primary operating channel of the access point.

According to another example of the techniques disclosed herein, a non-transitory computer-readable medium includes instructions for enabling access point discovery in a wireless network. The instructions, when executed by a processor, cause the processor to perform operations. The operations include scanning, at a station, a low energy protocol advertising channel for beacon information broadcasted from an access point. The beacon information is associated with operation of the access point according to a first protocol. The low energy protocol advertising channel is associated with a low energy protocol that is different from the first protocol. The first protocol is associated with a primary operating channel of the access point.

According to another example of the techniques disclosed herein, an apparatus includes means for scanning a low energy protocol advertising channel for beacon information at a station. The beacon information is broadcasted from an access point, and the beacon information is associated with operation of the access point according to a first protocol. The low energy protocol advertising channel is associated with a low energy protocol that is different from the first protocol. The first protocol is associated with a primary operating channel of the access point. The apparatus also includes means for obtaining identifying information regarding a particular identifiable access point based on the beacon information.

One advantage provided by at least one of the disclosed techniques is power conservation at stations in a wireless network. For example, the stations may operate according to a low energy protocol to conserve power and may receive advertisement packets (e.g., beacon information) indicating whether buffered downlink data is available at access point. Receiving advertisement packets according to the low energy protocol may reduce the requirement mandating that stations periodically enter an awake mode (e.g., a high power mode) to receive beacons over Wi-Fi channels, even though downlink data for the stations may not be buffered at the access point. Other implementations, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram of a system that is operable to support a low energy protocol for managing power in a wireless network;

FIG. 2 is a diagram of an advertisement packet that includes beacon information transmitted according to the low energy protocol of FIG. 1;

FIG. 3 is a flow diagram of an illustrative method for managing power in a wireless network;

FIG. 4 is a flow diagram of another illustrative method for managing power in a wireless network;

FIG. 5 is a diagram of a system that is operable to support a low energy protocol for access point discovery in a wireless network;

FIG. 6 is a diagram of another system that is operable to support a low energy protocol for access point discovery in a wireless network;

FIG. 7 is a flow diagram of an illustrative method for enabling access point discovery in a wireless network according to a low energy protocol;

FIG. 8 is a flow diagram of another illustrative method for enabling access point discovery in a wireless network according to a low energy protocol;

FIG. 9 is a flow diagram of another illustrative method for enabling access point discovery in a wireless network according to a low energy protocol; and

FIG. 10 is a diagram of a station that is operable to support various implementations of one or more methods, systems, apparatuses, and/or computer-readable media disclosed herein.

### VI. DETAILED DESCRIPTION

The present disclosure presents techniques and protocols for low energy power management in a wireless network. An access point in an Institute of Electrical and Electronics Engineers (IEEE) 802.11 network (e.g., a “Wi-Fi” network) may operate on a first frequency band (e.g., a 2.4 gigahertz (GHz) frequency band). The first frequency band may include a first set of channels (e.g., Wi-Fi channels) for communicating according to a Wi-Fi protocol (e.g., 802.11a, 802.11b, 802.11g, 802.11n, 802.11 ac, 802.11ad, 802.11 ah, etc.). The frequency band may also include a second set of channels that do not overlap with the first set of channels for communicating according to a low energy protocol. The low energy protocol may be a Bluetooth® Low Energy (BLE) protocol (Bluetooth® is a registered trademark of Bluetooth Special Interest Group (SIG), Inc. of Kirkland, Wash., USA) or 802.11ah. BLE may alternatively be referred to as Bluetooth® Smart.

The access point and one or more stations in the Wi-Fi network may be enabled to operate according to the low energy protocol. For example, each station in the Wi-Fi network may operate in an awake mode (e.g., a high power mode) and a sleep mode (e.g., a low power mode). During the awake mode, stations may be operable to communicate over the first set of channels using the Wi-Fi protocol and over the second set of channels using the low energy protocol. During the sleep mode, although stations may not be configured to transmit or receive data according to the first set of protocol (e.g., because associated radio frequency circuitry may be powered down), the stations may retain the ability to transmit or receive data via the second set of channels according to the low energy protocol. The access point may broadcast advertisement packets (e.g., beacon information) to the stations over a particular channel (e.g., a low energy protocol advertising channel) in the second set of channels while the stations are in the sleep mode. Each advertisement packet may include a traffic indication map indicating whether a particular station has buffered downlink data available at the access point. Upon receiving an advertisement packet indicating that buffered downlink data is available, the particular station may transition from the sleep mode to the awake mode (e.g., “wake up”) and communicate with the access point using a channel in the first set of channels to receive the buffered downlink data according to the Wi-Fi protocol. Communicating advertisement packets over the second set of channels according to the low energy protocol may enable the stations to remain in the sleep mode until receiving notification (e.g., a traffic indication map) that buffered downlink data is available at the access point. Thus, power may be conserved at the stations by reducing how often the stations switch to the awake mode to receive such traffic indication maps in beacons over the first set of channels according to the (higher power) first protocol.

For example, the stations may operate according to a low energy protocol to conserve power and may receive advertisement packets (e.g., beacon information) indicating whether buffered downlink data is available at access point. Receiving advertisement packets according to the low energy protocol may reduce the requirement mandating that stations periodically enter an awake mode (e.g., a high power mode) to receive beacons over Wi-Fi channels, even though downlink data for the stations may not be buffered at the access point.

Additionally, the present disclosure presents techniques and protocols for low energy access point discovery in a wireless network. An access point in a Wi-Fi network may advertise beacon information (e.g., “basic” beacon information) over a low energy protocol advertising channel according to a low energy protocol. The low energy protocol may be a BLE protocol. The beacon information may include a subset of information included in a “traditional” beacon advertised over a Wi-Fi channel according to a Wi-Fi protocol (e.g., 802.11a, 802.11b, 802.11g, 802.11n, 802.11 ac, 802.11ad, 802.11 ah, etc.). For example, the beacon information may include information elements (IEs) for basic service set (BSS) operation, radio resource management (a.k.a. 802.11k), etc. The IEs may indicate a primary operating channel number of the access point, a channel width of the operating channel, multiple-input multiple-output (MIMO) capabilities of the access point, etc. The IEs may also indicate a BSS load of the access point and a BSS access delay of the access point. In one example, the beacon information may also include fast initial link setup (FILS) information for other nearby access points, which may be part of other wireless networks.

One advantage provided by the disclosed techniques described above is a reduced initial scan time for a station (e.g., a mobile device) to find an access point. For example, the station may obtain information about one or more access points by scanning a low energy protocol advertising channel as opposed to scanning random Wi-Fi channels that may or may not have information about the one or more access points. A station in the Wi-Fi network may receive the advertised beacon information over the low energy protocol advertising channel and establish a link with the advertising access point (or with another nearby access point) based on the beacon information. Additionally, nearby access points (e.g., a second access point, a third access point, etc.) may receive the advertised beacon information over the low energy protocol advertising channel. Based on the advertised beacon information, a nearby access point may select an operating band/channel that is different from the primary operating band/channel of the advertising access point to reduce congestion on the primary operating band/channel of the advertising access point. For example, in response to determining that the advertising access point is operating on a first operating band/channel, the nearby access point may send a message to associated stations indicating that the nearby access point is selecting a second operating band/channel for use in communicating with the associated stations. The associated stations may tune to the second operating band/channel and the nearby access point may communicate data with the associated stations over the second operating band/channel. As a result, interference and/or medium congestion may be reduced on the first operating band/channel, the second operating band/channel, or both.

Particular implementations of the present disclosure are described with reference to the drawings. In the description, common features are designated by common reference numbers throughout the drawings.

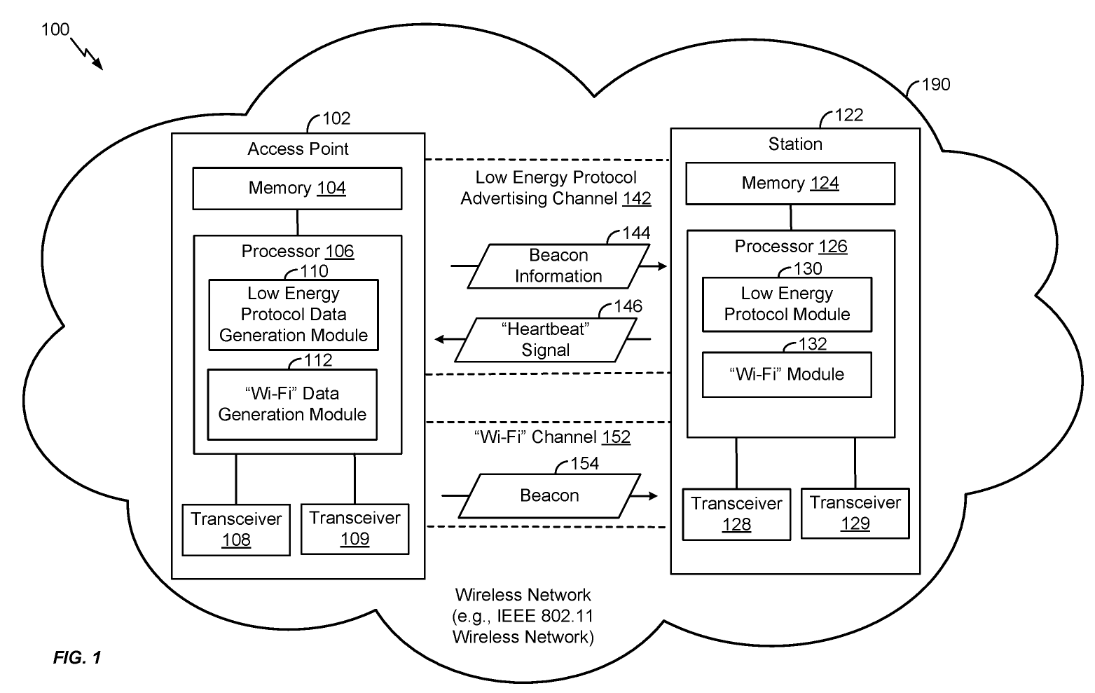

Referring to FIG. 1, a system 100 that is operable to support a low energy protocol for managing power in a wireless network is shown. The system 100 includes an access point 102 and a station 122 (e.g., a mobile device). It should be noted that additional (or fewer) access points may be present in the system 100. Additionally, it should be noted that although FIG. 1 depicts a single mobile device (e.g., the station 122), any number of mobile devices may be present in the system 100. The access point 102 and the station 122 may operate in compliance with one or more Institute of Electrical and Electronics Engineers (IEEE) 802.11 standards. As used herein, “IEEE 802.11” may be used interchangeably with “Wi-Fi”.

The access point 102 may be a node of a wireless network 190 (e.g., an IEEE 802.11 wireless network). For example, the access point 102 may be an IEEE 802.11 access point that supports (e.g., manages) the wireless network 190. The access point 102 includes a memory 104, a processor 106, a transceiver 108, and a transceiver 109. The memory 104 may be a non-transitory computer-readable medium that includes instructions that are executable by the processor 106.

The processor 110 may include a low energy protocol data generation module 110 and a Wi-Fi data generation module 112. The low energy protocol data generation module 110 may be configured to generate beacon information 144 according to a low energy protocol. The low energy protocol may include a Bluetooth® Low Energy (BLE) protocol (Bluetooth® is a registered trademark of Bluetooth Special Interest Group (SIG), Inc. of Kirkland, Wash., USA). BLE may alternatively be referred to as Bluetooth® Smart.

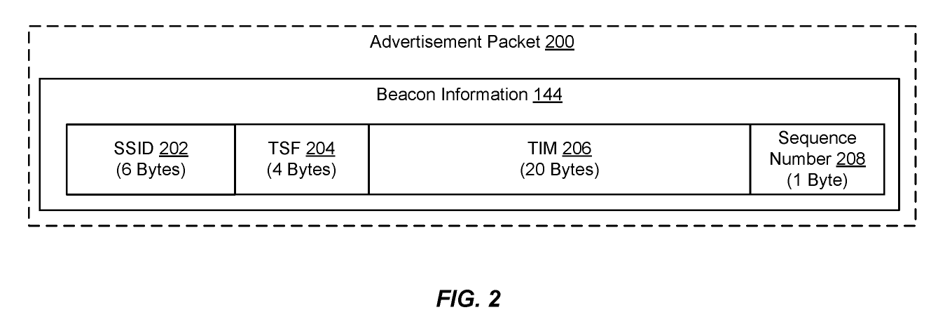

As further described with respect to FIG. 2, the beacon information of the first set of protocols 144 may be included in an advertisement packet sent with the low energy protocol. The beacon information 144 may include a subset of information that the access point 102 is additionally or alternatively configured to transmit using a beacon 154, as described below. The beacon information 144 may include a traffic indication map that indicates whether buffered downlink data designated for the station 122 is available at the access point 102. For example, the access point 102 may include a buffer (not shown) that is configured to store downlink data for the station 122 while the station 122 is in a sleep mode (e.g., a low power mode). The beacon information 144 may indicate to the station 122 that the downlink data is stored in the buffer (e.g., the downlink data is available). For example, a particular bit of a traffic indication map included in the beacon information 144 may be assigned to the station 122. The access point 102 may set the particular bit to a first value (e.g., 1) to indicate that buffered downlink data for the station 122 is available and may set the particular bit to a second value (e.g., 0) to indicate that buffered downlink data for the station 122 is not available.

The beacon information 144 may also include a sequence number that indicates whether an operation parameter change to a basic service set (BSS) of the wireless network 190 has occurred. For example, the access point 102 and the station 122 may be included in the BSS. Any change in the BSS (e.g., a new primary operating channel, a higher operation bandwidth, etc.) may be indicated by a change in the sequence number.

The Wi-Fi data generation module 112 may be configured to generate the beacon 154. The beacon 154 may include timestamp information, beacon interval information, network capability information, a service set identification (SSID), information associated with supported data rates, a frequency-hopping parameter set, a direct-sequence parameter set, a contention-free parameter set, a traffic indication map, etc. Thus, in particular implementations, the beacon information 144 may include any of the information that is included in the beacon 154.

The access point 102 may be configured to send (e.g., broadcast) the beacon information 144 to the station 122 (and to other stations within a broadcast range of the access point 102) according to the low energy protocol. To illustrate, the transceiver 108 may be a low energy protocol transceiver that is operable to send (e.g., broadcast) the beacon information 144 to the station 122 according to the low energy protocol. The transceiver 108 may send (e.g., broadcast) the beacon information 144 to the station 122 over a low energy protocol advertising channel 142. The low energy protocol advertising channel 142 may be included in a 2.4 gigahertz (GHz) frequency band. For example, the low energy protocol advertising channel 142 may be a non-overlapping channel with respect to Wi-Fi channels (e.g., a Wi-Fi channel 152) in the 2.4 GHz frequency band.

The access point 102 may also be configured to send (e.g., broadcast) the beacon 154 to the station 122 (and to other stations within a broadcast range of the access point 102) according to a Wi-Fi protocol. To illustrate, the transceiver 109 may be a Wi-Fi protocol transceiver that is operable to send (e.g., broadcast) the beacon 154 to the station 122 according to the Wi-Fi protocol. The transceiver 109 may send (e.g., broadcast) the beacon 154 to the station 122 over the Wi-Fi channel 152. The Wi-Fi channel 152 may also be included in the 2.4 GHz frequency band (e.g., in the same frequency band as the low energy protocol channel 142). Beacons, such as the beacon 154, may be sent to the station 152 at regular intervals. For example, the access point 102 may send (e.g., broadcast) a beacon 154 to the station 122 (and to other stations within a broadcast range of the access point 102) approximately every 100 milliseconds (ms). The beacon information 144 may be sent at intervals substantially synchronized with intervals that beacons 154 are advertised by the access point 102 over the Wi-Fi channel 152. For example, the access point 102 may send (e.g., broadcast) the beacon information 144 to the station 122 approximately every 100 ms. In one example, the beacon information 144 and the beacon 154 may be sent approximately simultaneously. To illustrate, the beacon information 144 and the beacon 154 may be sent at a first time (t=0), a second time (t=100), a third time (t=200), etc. In another example, the beacon information 144 and the beacon 154 may be sent at staggered time intervals. To illustrate, the beacon information 144 may be sent at the first time (t=0), the second time (t=100), the third time (t=200), etc., and the beacon 154 may be sent at a fourth time (t=50), a fifth time (t=150), a sixth time (t=250), etc.

The station 122 may be an electronic device that is operable to send and receive data via the wireless network 190. For example, the station 122 may be a wireless phone, a personal digital assistant (PDA), a portable computing device, a tablet computing device, a portable media player, or a combination thereof. The station 122 includes a memory 124, a processor 126, a transceiver 128, and a transceiver 129. The memory 124 may be a non-transitory computer-readable medium that includes instructions that are executable by the processor 126.

The processor 126 may include a low energy protocol module 130 and a Wi-Fi module 132. According to the techniques described herein, the station 122 may operate in an awake mode (e.g., a high power mode) and may operate in a sleep mode (e.g., a low power mode). In the awake mode, the low energy protocol module 130, the transceiver 128, the Wi-Fi module 132, and the transceiver 129 may be operational. For example, the low energy protocol module 130 may be operable to process data (e.g., the beacon information 144) received from the access point 102 in the awake mode, and the Wi-Fi module 132 may be operable to process data (e.g., the beacon 154) received from the access point 102 in the awake mode. In the sleep mode, the low energy protocol module 130 and the transceiver 128 may be operational, and the Wi-Fi module 132 and the transceiver 129 may be in a low power state (e.g., non-operational) to conserve battery power at the station 122. For example, the low energy protocol module 130 may be operable to process the beacon information 144 received from the access point 102 in the sleep mode, and the Wi-Fi module 132 may not be operable to process the beacon 154 received from the access point 102 in the sleep mode.

Thus, while the station 122 is in the sleep mode, the transceiver 128 may receive the beacon information 144 from the access point 102 over the low energy protocol advertising channel 142. In this example, the transceiver 128 may be a low energy protocol transceiver that is operable to receive the beacon information 144 while the station 122 is in the sleep mode. For example, the station 122 may monitor BLE broadcasts (e.g., broadcasts of the beacon information 144) from the access point 102 over the low energy protocol advertising channel 142. The station may tune to the low energy protocol advertising channel 142 and “look for” the beacon information 144 at regularly scheduled intervals (e.g., intervals substantially synchronized with Wi-Fi beacon intervals). Thus, by tuning to the low energy protocol advertising channel 142 at regular scheduled intervals instead of randomly scanning a plurality of channels, power efficiency at the station 122 for BLE protocol communication may be improved.

The low energy protocol module 130 may process the beacon information 144 while the station 122 is in the sleep mode. For example, the low energy protocol module 130 may determine whether a traffic indication map in the beacon information 144 indicates that the buffered downlink data for the station 122 is available at the access point 102. If buffered downlink data is available for the station 122, the low energy protocol module 130 may cause the station 122 to transition from the sleep mode to the awake mode (e.g., “power up” or “wake up” the Wi-Fi module 132 and the transceiver 129), and the station 122 may perform Wi-Fi operations (e.g., to request and/or retrieve the buffered downlink data) as if the traffic indication map was received in a Wi-Fi beacon (e.g., the beacon 154). For example, when the station 122 is in the awake mode, the Wi-Fi module 132 may generate a command instructing the access point 102 to send the buffered data to station 122 and may send the command to the access point 102 over the Wi-Fi channel 152 via the transceiver 129. For example, the transceiver 129 may be a Wi-Fi protocol transceiver that is operable to send data to (and receive data from) the access point 102 via the Wi-Fi channel 152. The access point 102 may send the buffered downlink data to the station 122 over the Wi-Fi channel 152 in response to the command and the Wi-Fi module 132 may process the buffered downlink data. While in the awake mode, the station 122 may also send uplink data to the access point 102 (e.g., for forwarding to other stations of the wireless network 190 and/or to devices external to the wireless network 190).

Additionally, the low energy protocol module 130 may determine whether a sequence number in the beacon information 144 indicates that a change to the BSS has occurred since the station 122 entered the sleep mode. For example, the station 122 may store a “last known” sequence number, and if the sequence number in the received beacon information 144 is more recent (e.g., greater) than the “last known” sequence number, the station 122 may determine that a BSS change has occurred. If a change to the BSS has occurred, the low energy protocol module 130 may cause the station 122 to transition from the sleep mode to the awake mode. When the station 122 is in the awake mode, the transceiver 129 may receive the beacon 154 from the access point 102 over the Wi-Fi channel 152, and the Wi-Fi module 132 may process the beacon 154. The beacon 154 may include additional information (as compared to the information in the beacon information 144) to enable the station 122 to process the change to the BSS.

In a particular implementation, the station 122 may send a signal (e.g., a “heartbeat” signal 146) to the access point 102 over the low energy protocol advertising channel 142 while the station 122 is in the sleep mode. The heartbeat signal 146 may indicate to the access point 102 that the station 122 remains “associated with” the access point 102. For example, upon receiving the heartbeat signal 146, the access point 102 may maintain a Wi-Fi connection (e.g., an IEEE 802.11 association) and/or associated connection state (e.g., routing table information, internet protocol (IP) address assignment, security/encryption information, resource reservation information, etc.) with the station 122. Thus, even though the techniques of the present disclosure may enable the station 122 to wake up less frequently to receive Wi-Fi beacons, the station 122 may use the “heartbeat” signal 146 to maintain association with the access point 102 and prevent the access point 102 from interpreting the lack of Wi-Fi communication from the station 122 as an indication that the station 122 has been turned off or has left a coverage area of the wireless network 190.

The system 100 of FIG. 1 may enable the station 122 to remain in the sleep mode for longer periods of time, which in turn may reduce power consumption at the station 122. For example, while the station 122 is in the sleep mode, the low energy protocol module 130 may monitor BLE broadcasts from the access point 102 over the low energy protocol advertising channel 142. Based on the BLE broadcast (e.g., the beacon information 144), the low energy protocol module 130 may transition the station 122 into the awake mode to communicate with the access point 102 over the Wi-Fi channel 152. Thus, Wi-Fi operations (e.g., high power operations) at the station 122 may be postponed/scheduled based on BLE operations (e.g., low power operations) at the station 122, which in turn may reduce power consumption at the station 122.

Referring to FIG. 2, a particular illustrative example of the beacon information 144 transmitted over the low energy protocol advertising channel 142 is shown. The beacon information 144 may be included in an advertisement packet 200. For example, the access point 102 of FIG. 1 may send (e.g., broadcast) the advertisement packet 200 to the station 122 (and to other stations within a broadcast range of the access point 102) over the low energy protocol advertising channel 142 according to the low energy protocol (e.g., the BLE protocol).

The beacon information 144 may include a service set identification (SSID) field 202, a timing synchronization function (TSF) field 204, a traffic indication map (TIM) field 206, and a sequence number field 208. The SSID field 202 may be a 6-byte field, the TSF field 204 may be a 4-byte field, the TIM field 206 may be a 20-byte field, and the sequence number field 208 may be a 1-byte field. However, it is to be understood that in alternative implementations, the beacon information 144 may have longer, shorter, more, fewer, and/or different fields than shown in FIG. 2. Moreover, the advertisement packet 200 may include additional data besides the beacon information, such as a header, training fields, etc.

The SSID field 202 may include information identifying the BSS of the access point 102 and the TSF field 204 may include timing information to synchronize different nodes in the BSS. For example, the TSF field 204 may include timing synchronization function information that enables the station 122 to synchronize with the access point 102. The TIM field 206 may indicate whether buffered downlink data designated for one or more stations (e.g., including the station 122) is available at the access point 102. In a particular implementation, the access point 102 may include TIM information for BLE-enabled stations (e.g., the station 122), but does not include TIM information for stations that are not BLE-enabled, because such stations may be incapable of receiving and processing the beacon information 144. Thus, in a particular implementation, an access point may maintain a list of associated stations that are BLE-enabled (e.g., a station may notify an access point that the station is BLE-enabled during an association process with the access point).

The sequence number field 208 may indicate whether a change to the BSS of the wireless network 190 has occurred. For example, a sequence number in the sequence number field 208 may be initialized to zero and may be incremented when a “critical” update occurs to an element inside of a beacon frame (e.g., the beacon 154). Thus, when the sequence number increments, the station 122 may transition to the awake mode to receive the beacon 154 on the Wi-Fi channel 152 and process information associated with the update.

The beacon information 144 of FIG. 2 may enable the station 122 of FIG. 1 to remain in the sleep mode for a relatively long period of time, which in turn may reduce power consumption at the station 122. For example, the beacon information 144 may be processed at the station 122 according to the BLE protocol (e.g., a low energy protocol) while the station 122 is in the sleep mode. If the beacon information 144 indicates a scenario for Wi-Fi processing at the station 122, the station 122 may enter the awake mode. Otherwise, the station 122 may remain in the sleep mode to conserve power.

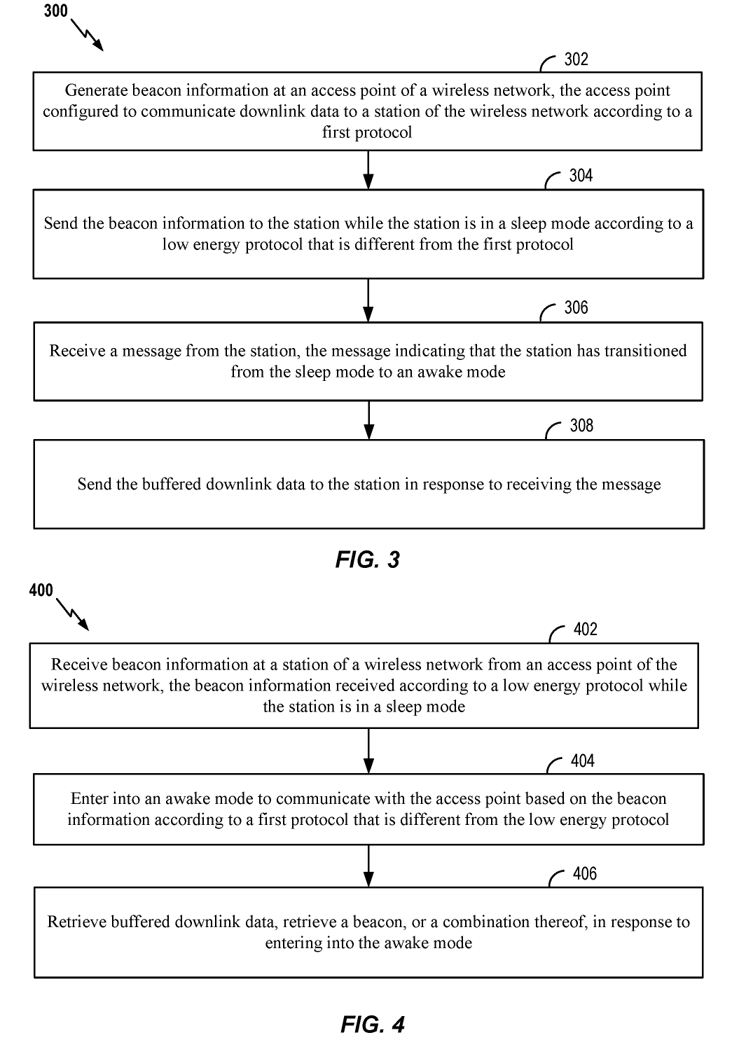

Referring to FIG. 3, a method 300 for managing power in a wireless network is shown. In an illustrative implementation, the method 300 may be performed using the access point 102 of FIG. 1.

The method 300 includes generating beacon information at an access point of a wireless network, at 302. The access point may be configured to communicate downlink data to a station of the wireless network according to a first protocol. For example, referring to FIG. 1, the low energy protocol data generation module 110 may be configured to generate the beacon information 144 according to the low energy protocol (e.g., the BLE protocol). The beacon information 144 may include a subset of information in the beacon 154. As described with respect to FIG. 2, the beacon information 144 may include a traffic indication map that indicates whether buffered downlink data designated for the station 122 is available at the access point 102. The beacon information 144 may also include a sequence number that indicates whether a change to the BSS of the wireless network 190 has occurred.

The beacon information may be sent to a station while the station is in a sleep mode according to a low energy protocol that is different from the first protocol, at 304. For example, referring to FIG. 1, the access point 102 may send (e.g., broadcast) the beacon information 144 to the station 122 over the low energy protocol advertising channel 142 while the station 122 is in the sleep mode. The station 122 may be operable to receive (via the transceiver 128) and process the beacon information 144 while the station 122 is in the sleep mode according to the BLE protocol.

The method 300 may also include receiving a message from the station, at 306. The message may indicate that the station has transitioned from the sleep mode to an awake mode. For example, referring to FIG. 1, the access point 102 may receive a message (e.g., a PS-Poll frame, a Null frame, or a data frame based on an unscheduled automatic power save delivery (U-APSD) operation such as a U-APSD trigger frame) from the station 122 via the low energy channel 142 and/or via the Wi-Fi channel 152 indicating that that the station 122 has transitioned from the sleep mode to the awake mode.

The method 300 may also include sending the buffered downlink data to the station in response to receiving the message, at 308. For example, referring to FIG. 1, the access point 102 may send (e.g., broadcast) the buffered downlink data to the station 122 via the Wi-Fi channel 152 in response to receiving the message indicating that the station 122 has transitioned from the sleep mode to the awake mode.

The method 300 of FIG. 3 enables the access point 102 to communicate traffic and BSS update information over the low energy protocol, which in turn may enable the station 122 to wake up and perform higher power protocol operations less often. For example, even if buffered downlink data for the station 122 is not available at the access point 102, existing implementations may require the station 122 to periodically wake up and perform higher power protocol operations to receive and process a traffic indication map. In accordance with the described techniques, a traffic indication map may be received over a lower power protocol, and the station 122 may defer waking up and performing higher power operations until the traffic indication map indicates that buffered downlink data is available (or until the station 122 determines that a “critical” update has occurred while the station 122 was in the sleep mode).

Referring to FIG. 4, another method 400 for managing power in a wireless network is shown. In an illustrative implementation, the method 400 may be performed using the station 122 of FIG. 1.

The method 400 includes receiving beacon information at a station of a wireless network from an access point of the wireless network, at 402. The beacon information may be received according to a low energy protocol while the station is in a sleep mode. For example, referring to FIG. 1, while the station 122 is in the sleep mode, the transceiver 128 may receive the beacon information 144 from the access point 102 over the low energy protocol advertising channel 142. For example, the station 122 may monitor BLE broadcasts (e.g., broadcasts of the beacon information 144) from the access point 102 over the low energy protocol advertising channel 142. Thus, the station may tune to the low energy protocol advertising channel 142 and “look for” the beacon information 144 at regularly scheduled intervals (e.g., intervals substantially synchronized with Wi-Fi beacon intervals).

The station may enter into an awake mode to communicate with the access point based on the beacon information according to a first protocol that is different from the low energy protocol, at 404. For example, referring to FIG. 1, the beacon information 144 may be processed at the station 122 according to the BLE protocol (e.g., a low energy protocol) while the station 122 is in the sleep mode. If the beacon information 144 indicates a scenario for Wi-Fi processing (e.g., processing according to the first protocol) at the station 122, the station 122 may enter the awake mode.

The method 400 may also include retrieving buffered downlink data, receiving a beacon, or a combination thereof, in response to entering into the awake mode, at 406. For example, if the TIM field 206 in FIG. 2 indicates that there is buffered downlink data for the station 122 stored at the access point 102, the station make enter the awake mode to retrieve the buffered downlink data over the Wi-Fi channel 152. As another example, if the sequence number field 208 in FIG. 2 indicates that a “critical” update to an element inside of the beacon 154 has occurred, the station 122 may enter the awake mode to receive the beacon 154 on the Wi-Fi channel 152 and process information associated with the update. In another example, the station 122 may receive the beacon 154 on a BLE data channel (not shown) according to the BLE protocol if the sequence number field 208 indicates that a “critical” update to an element inside of the beacon 154 has occurred.

The method 400 of FIG. 4 may enable the station 122 of FIG. 1 to remain in the sleep mode for a relatively long period of time, which in turn may reduce power consumption at the station 122. For example, the beacon information 144 may be processed at the station 122 according to the BLE protocol (e.g., a low energy protocol) while the station 122 is in the sleep mode. If the beacon information 144 indicates a scenario for Wi-Fi processing at the station 122, the station 122 may enter the awake mode. Otherwise, the station 122 may remain in the sleep mode to conserve power.

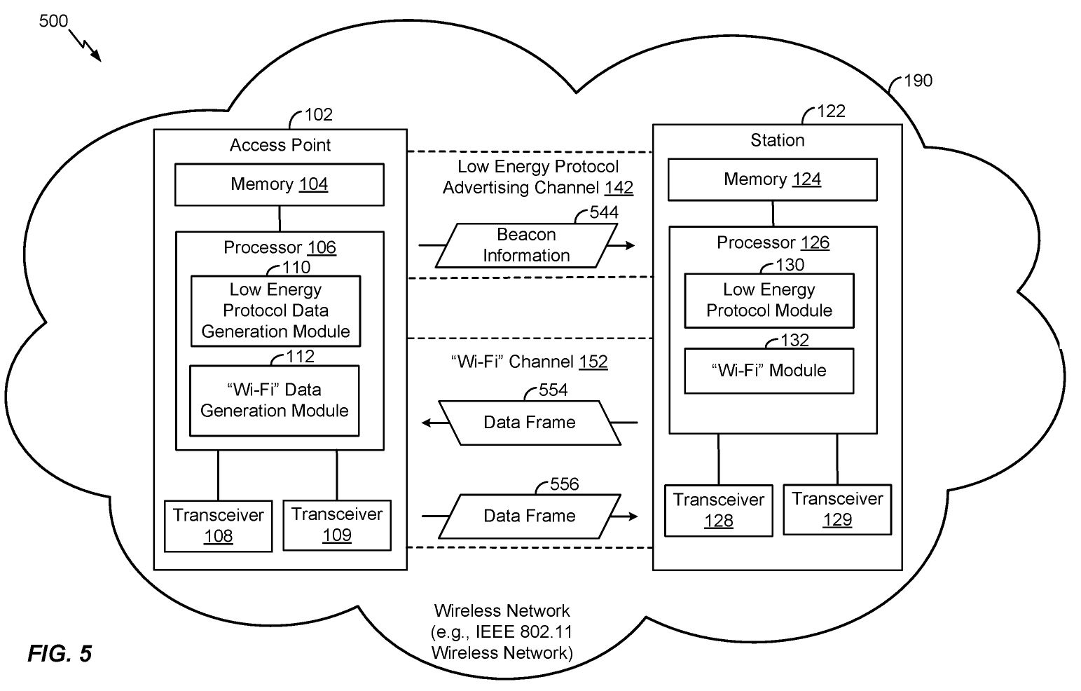

Referring to FIG. 5, a system 500 that is operable to enable access point discovery in a wireless network is shown. The system 500 includes the access point 102 and the station 122. It should be noted that additional access points may be present in the system 500. Additionally, it should be noted that although FIG. 5 depicts a single mobile device (e.g., the station 122), any number of mobile devices may be present in the system 500.

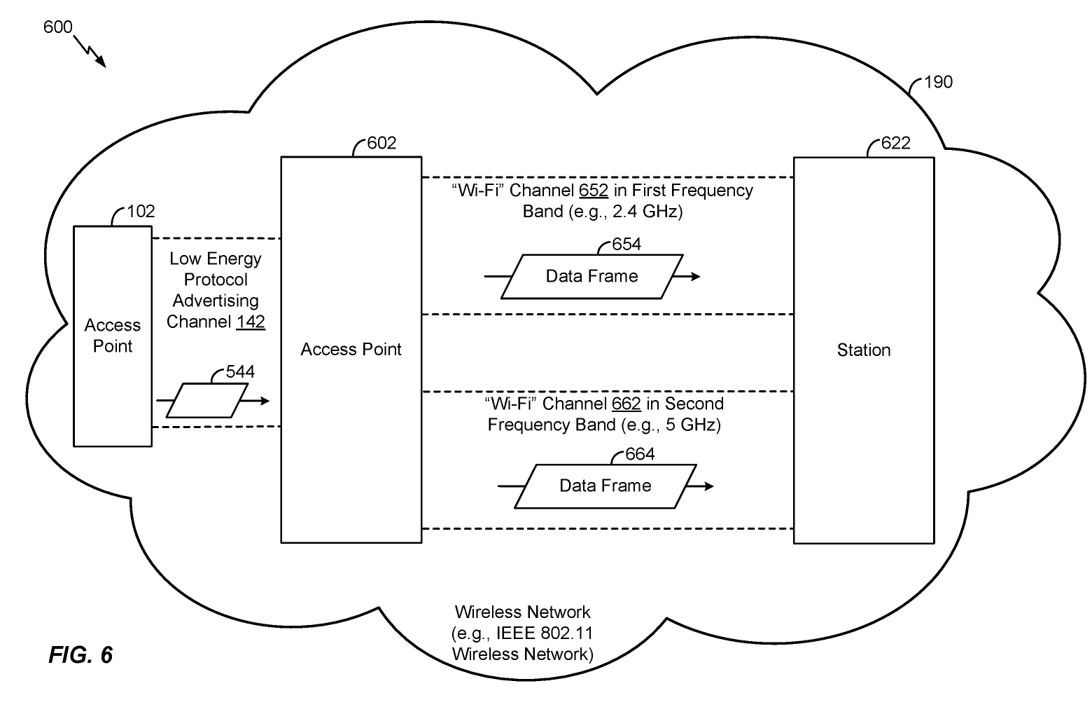

The low energy protocol data generation module 110 may be configured to generate beacon information 544 according to a low energy protocol. The beacon information 544 may include a subset of information included in a “traditional” beacon advertised over the Wi-Fi channel 152 according to a first protocol (e.g., a Wi-Fi protocol). In one non-limiting example, the beacon information 544 may include information elements (IE) for basic service set (BSS) operation, and/or IEs for an Institute of Electrical and Electronics Engineers (IEEE) 802.11k radio resource management, or a combination thereof. The IEs may indicate a primary operating channel (e.g., the Wi-Fi channel 152) of the access point 102, a channel width of the operating channel (e.g., 20 Megahertz (MHz) channel width, 40 MHz channel width, etc.), multiple-input multiple-output (MIMO) capabilities of the access point 102 (e.g., 2×2 MIMO, 3×3 MIMO, etc.), or a combination thereof. The IEs may also indicate a BSS load associated with the access point 102, a BSS access delay associated with the access point 102, or a combination thereof. The BSS load may correspond to an amount of traffic in the primary operating channel (e.g., the Wi-Fi channel 152), and the BSS access delay may correspond to an amount of time associated with transmitting a data packet from the access point 102 to at least one other device (e.g., the station 122) via the primary operating channel. Thus, in particular implementations, the beacon information 544 may include information associated with Wi-Fi operation of the access point 102, including but not limited to “discovery” information that may assist a station (e.g., the station 122) in associating with the access point 102. Alternatively, or in addition, the beacon information 544 may include similar information (e.g., “neighbor information”) for other nearby access points (not shown), such as other access points that are part of the wireless network 190 and/or part of other wireless networks. The neighbor information may have previously been received by the access point 102 via the low energy protocol advertising channel 142, as further described with reference to FIG. 6. Thus, in particular implementations, the beacon information 544 may not only include discovery information for the access point 102, but may also include discovery information for one or more nearby access points to enable the station 122 to initiate link setup with a nearby access point without waiting to receive a beacon or other discovery message from the nearby access point.

The Wi-Fi data generation module 112 may be configured to generate one or more data frames, such as a data frame 556, according to the first protocol. As described below, in one non-limiting example, the data frame 556 may include an acknowledgement frame that is used to establish a communication link between the access point 102 and the station 122.

The access point 102 may be configured to broadcast (e.g., send) the beacon information 544 to the station 122 according to the low energy protocol. Although one or more operations herein may be described as including “sending” the beacon information 544 to the station 122, it is to be understood that the beacon information 544 need not be unicast or directed specifically to the station 122. The beacon information 544 may be “sent” to the station 122 by virtue of the station 122 receiving a broadcast of the beacon information 544. Thus, it is to be understood that such broadcast beacon information 544 may also be received by other devices (not shown) that are within communication range of the access point 102 and that are equipped to receive data via the low energy protocol advertising channel 142.

In a particular implementation, the transceiver 108 may be a low energy protocol transceiver that is operable to broadcast the beacon information 544 to the station 122 according to the low energy protocol. The transceiver 108 may send the beacon information 544 to the station 122 over the low energy protocol advertising channel 142. The low energy protocol advertising channel 142 may be included in a 2.4 gigahertz (GHz) frequency band. For example, the low energy protocol advertising channel 142 may be a non-overlapping channel with respect to Wi-Fi channels (e.g., the Wi-Fi channel 152) in the 2.4 GHz frequency band. The beacon information 544 may be broadcasted to the station 122 at regular intervals. For example, the access point 102 may send the beacon information 544 to the station 122 approximately every 500 ms.

The access point 102 may also be configured to send the data frame 556 to the station 122 according to the Wi-Fi protocol. To illustrate, the transceiver 109 may be a Wi-Fi protocol transceiver that is operable to send the data frame 556 to the station 122 according to the Wi-Fi protocol. The transceiver 109 may send the data frame 556 to the station 122 over the Wi-Fi channel 152. The Wi-Fi channel 152 may also be included in the 2.4 GHz frequency band (e.g., in the same frequency band as the low energy protocol channel 142).

Thus, the techniques described herein support broadcasting the beacon information 544 to at least one other device (e.g., the station 122) of the wireless network 190 according to the low energy protocol (e.g., the BLE protocol). The low energy protocol is different from the first protocol (e.g., the Wi-Fi protocol) used to communicate data (e.g., the data frame 556) to the at least one other device.

The station 122 may be configured to scan the low energy protocol advertising channel 142 of the wireless network 190 for the beacon information 544 broadcasted from the access point 102. To illustrate, the transceiver 128 may scan the low energy protocol advertising channel 142 to receive the beacon information 544 from the access point 102. In this example, the transceiver 128 may be a low energy protocol transceiver that is operable to receive the beacon information 544. For example, the station 122 may monitor BLE broadcasts (e.g., broadcasts of the beacon information 544) from the access point 102 over the low energy protocol advertising channel 142. The station may tune to the low energy protocol advertising channel 142 and “look for” the beacon information 544 at regularly scheduled intervals. Thus, by tuning to the low energy protocol advertising channel 142 for the beacon information 544 instead of randomly scanning a plurality of Wi-Fi channels for beacons, the amount of time and energy for discovering access point connectivity information may be improved (e.g., reduced).

The station 122 may be operable to obtain identifying information regarding a particular identifiable access point (e.g., the access point 102 or another nearby access point) based on the beacon information 544. As a non-limiting example, the identifying information may include the primary operating channel of the particular identifiable access point. To illustrate, the low energy protocol module 130 may process the beacon information 544 to determine the primary operating channel of the particular identifiable access point.

Based on a determination of the primary operating channel, the Wi-Fi module 132 may establish a communication link with the particular identifiable access point. For example, if the access point 102 is the particular identifiable access point, the Wi-Fi module may generate an authentication frame (e.g., a data frame 554), and the transceiver 129 may transmit the authentication frame to the access point 102 via the primary operating channel (e.g., the Wi-Fi channel 152) of the access point 102 according to the first protocol (e.g., the Wi-Fi protocol). To illustrate, the transceiver 129 may be a Wi-Fi protocol transceiver that is operable to send the data frame 554 to (and receive the data frame 556 from) the access point 102 via the Wi-Fi channel 152. In this example, the data frame 554 may be an authentication frame in a “handshake” routine, and the data frame 556 may be a response or acknowledgement frame in the handshake routine. After completion of the handshake routine (e.g., after the communication link between the access point 102 and the station 122 is established), data may be communicated between the access point 102 and the station 122 via the Wi-Fi channel 152.

Thus, the system 500 of FIG. 5 may enable out-of-band discovery of BLE-assisted access points at the station 122. For example, the station 122 may “discover” the access point 102 by tuning to the low energy protocol advertising channel 142 for the beacon information 544 instead of randomly scanning a plurality of Wi-Fi channels for beacons. Thus, although the station 122 is illustrated in FIG. 5 as being “within” the wireless network 190, it is to be understood that the station 122 may or may not have performed Wi-Fi association with the access point 102 at the time the beacon information 544 is received. If the station 122 is “unassociated” with the access point 102, scanning the low energy protocol advertising channel 142 for the beacon information 544 may enable fast discovery of BLE-assisted access points (e.g., the access point 102) without active scanning (e.g., probing access points on a plurality of Wi-Fi channels) and without passive scanning (e.g., “listening” for beacons on a plurality of Wi-Fi channels). In some implementations, it may take seconds to find a “preferred” access point using active scanning techniques and/or passive scanning techniques. For example, it may take seconds to scan each Wi-Fi channel in the 2.4 GHz frequency band and to scan each Wi-Fi channel in the 5 GHz frequency band for beacons/probe responses. Scanning the low energy protocol advertising channel 142 may reduce (e.g., eliminate) probing across the Wi-Fi channels in the 2.4 GHz frequency band and the Wi-Fi channels in the 5 GHz frequency band. For example, targeted probing may be performed by sending a probe request on the low energy protocol advertising channel 142 to retrieve information about access points of the wireless network 190. Additionally, because BLE may usually be in an active state at the station 122 (e.g., for peer-to-peer (P2P) operations), additional power savings on WiFi may be realized. Thus, a station that is not part of the wireless network 190 (e.g., a station that has not yet performed a Wi-Fi link setup with the access point 102) may receive the broadcast beacon information 544 if the station is compatible with the low energy protocol (e.g., if the station includes a BLE transceiver). Such a station may use the beacon information 544 to initiate link setup with the access point 102 and join the wireless network 190 (e.g., without having to scan Wi-Fi channels for discovery information broadcast by the access point 102). Alternatively or in addition, if the beacon information 544 includes discovery information for a neighboring access point, the station may use the beacon information 544 to initiate link setup with the neighboring access point.

If the station 122 is “associated” with an access point (e.g., communicating with an access point on a Wi-Fi channel) or in a P2P mode with another station, using the low energy protocol advertising channel 142 may reduce scanning overhead and delay associated with probing a plurality Wi-Fi channels. For example, by using the low energy protocol advertising channel 142 for access point discovery, little or no interruption to ongoing communication may be realized while scanning for the beacon information 544 according to the BLE protocol. Additionally, a seamless handoff (e.g., a handoff of the station 122 from the access point 102 to another access point) may be facilitated by reducing the scanning delay that would otherwise be associated with scanning a plurality of Wi-Fi channels.

Referring to FIG. 6, another system 600 that is operable to enable access point discovery in a wireless network is shown. The system 600 includes the access point 102, an access point 602, and a station 622 (e.g., a mobile device). It should be noted that additional access points may be present in the system 600. Additionally, it should be noted that although FIG. 6 depicts a single mobile device (e.g., the station 622), any number of mobile devices may be present in the system 600. The access points 102, 602 and the station 622 may operate in compliance with one or more IEEE 802.11 standards.

The access point 602 may include substantially similar components as the access point 102, as described with respect to FIG. 5. For example, the access point 602 may include a memory (not shown), a processor (not shown) having a low energy (e.g., BLE) protocol module and a Wi-Fi module, a low energy protocol transceiver (not shown), and a Wi-Fi transceiver. In the illustrative example, the access point 602 may be a dual-band access point. For example, the access point 602 may operate on a first frequency band (e.g., a 2.4 GHz frequency band) and on a second frequency band (e.g., a 5 GHz frequency band). The station 622 may include substantially similar components as the station 122, as described with respect to FIG. 5. For example, the station 622 may include a memory (not shown), a processor (not shown) having a low energy protocol module and a Wi-Fi module, a low energy protocol transceiver (not shown), and a Wi-Fi transceiver.

The access point 102 may be configured to broadcast (e.g., send) the beacon information 544 to the access point 602 according to the low energy protocol. To illustrate, the access point 102 may “send” the beacon information 544 to the access point 602 over the low energy protocol advertising channel 142. As explained above with reference to FIG. 5, it is to be understood that the beacon information 544 may be considered as being “sent” to the access point 602 by virtue of the access point 602 having a low energy protocol transceiver and receiving the beacon information 544 over the low energy protocol advertising channel 142. The low energy protocol advertising channel 142 may be included in the first frequency band (e.g., the 2.4 GHz frequency band).

The access point 602 may scan the low energy protocol advertising channel 142 of the wireless network 190 for the beacon information 544 broadcasted from the access point 102. Thus, the techniques described herein support scanning, at a first access point, a low energy protocol advertising channel for beacon information broadcasted from a second access point. The first and second access points may be part of the same wireless network (e.g., the wireless network 190) or may be part of different wireless networks. The access point 602 may operate on a primary operating channel. The primary operating channel may be a Wi-Fi channel 652 in the first frequency band or a Wi-Fi channel 662 in the second frequency band. The low energy protocol advertising channel 142 is associated with the low energy protocol (e.g., the BLE protocol), and the low energy protocol may be different from a first protocol (e.g., a Wi-Fi protocol) associated with the primary operating channel of the access point 602.

Upon receiving the beacon information 544 via the low energy protocol advertising channel 142, the access point 602 may use information about neighboring access points (e.g., the access point 102) in the beacon information 544 to assist with band selection and/or channel selection. The access point 602 may also store such neighbor information, so that the neighbor information can be included in a subsequent BLE broadcast by the access point 602. In one example, the access point 602 may determine which frequency bands and which frequency channels neighboring access points are operating on based on the beacon information 544. The access point 602 may be configured to change its own primary operating band and/or the primary operating frequency channel to be different frequency band from the operating band and/or a different frequency channel from the operating frequency channel of the neighboring access points.

To illustrate, assume that the Wi-Fi channel 652 in the first frequency band (e.g., the 2.4 GHz frequency band) is the primary operating channel of the access point 602. If the access point 602 determines based on the beacon information 544 that a neighboring access point (e.g., the access point 102) is also operating on the Wi-Fi channel 652, the access point 602 may change its primary operating channel to a different channel. For example, the access point 602 may change the primary operating channel to a different channel in the first frequency band or may change primary operating channel to a channel in the second frequency band (e.g., the Wi-Fi channel 662 in the 5 GHz frequency band). Additionally, or in the alternative, if the access point 602 determines that a neighboring access point is operating on the first frequency band (but on a different channel than the Wi-Fi channel 652), the access point 602 may change the primary operating band to the second frequency band.

Upon receiving the beacon information 544 via the low energy protocol advertising channel 142, the access point 602 may also use information about neighboring access points in the beacon information 544 to assist with station steering. For example, if the station 622 is associated with the access point 602, the access point 602 may send a message to the station 622 in response to receiving the beacon information 544. The message may indicate to the station 622 to associate with a different access point, such as the access point 102, that may be able to “serve” the station 622 better. For example, the access point 102 may have less congestion on its primary operating channel, which may enable the station 622 to communicate at improved data rates as compared to communication with the relatively “saturated” access point 602.

To illustrate, if the station 622 is associated with the access point 602 and the primary operating channel of the access point 602 is the Wi-Fi channel 652, the access point 602 may send a data frame 654 to station 622. The data frame 654 may include a message that instructs the station 622 to associate with a different access point, such as the access point 102 or another access point identified by the beacon information 544. If the station 622 is associated with the access point 602 and the primary operating channel of the access point 602 is the Wi-Fi channel 662, the access point 602 may send a data frame 664 to the station. The data frame 664 may include a message (e.g., based on 802.11v) that instructs the station to associate with a different access point, such as the access point 102 or another access point identified by the beacon information 544.

As another non-limiting example of station steering, the access point 602 may steer the station 622 to operate on a different frequency band of the access point 602. For example, the access point 602 may be a dual-band concurrent access point operating on the first frequency band (e.g., the 2.4 GHz frequency band) and on the second frequency band (e.g., the 5 GHz frequency band). If the station 622 is associated with the access point 602 and communicating with the access point 602 over the first frequency band, based on the beacon information 544, the access point 602 may steer the station 622 to operate on the second frequency band because the first frequency band is “busy”. For example, the access point 602 may send a message to the station 622 to switch operating bands based on the beacon information 544.

The system 600 of FIG. 6 may enable out-of-band discovery of BLE-assisted access points at the access point 602. For example, the access point 602 may receive information about neighboring access points (via the beacon information 544 sent on the low energy protocol advertising channel 142) while maintaining operations on the access point's 602 primary operating channel (e.g., the Wi-Fi channel 652 or the Wi-Fi channel 662). Thus, the access point 602 may “discover” the access point 102 and/or other neighboring access points by receiving the broadcasted beacon information 544 on the low energy protocol advertising channel 142 and without scanning Wi-Fi channels. Access point to access point coordination via backhaul techniques may be reduced based on the out-of-band discovery. For example, even if the access point 102 is associated with a first enterprise or vendor and the access point 602 is associated with a second enterprise or vendor, the access points 102, 602 may nonetheless “discover” one another via the BLE protocol, which may substantially reduce backhaul constraints. In one example, the access point 602 may connect to the access point 102 via the Wi-Fi protocol to retrieve additional information about the access point 102. For example, the access point 602 may tune to the primary operating channel of the access point 102 (based on data in the beacon information 544) and may retrieve additional broadcasts from the access point 102 via the primary operating channel of the access point 102. The described techniques thus enable information sharing between access points via a low energy protocol channel (e.g., a BLE channel).

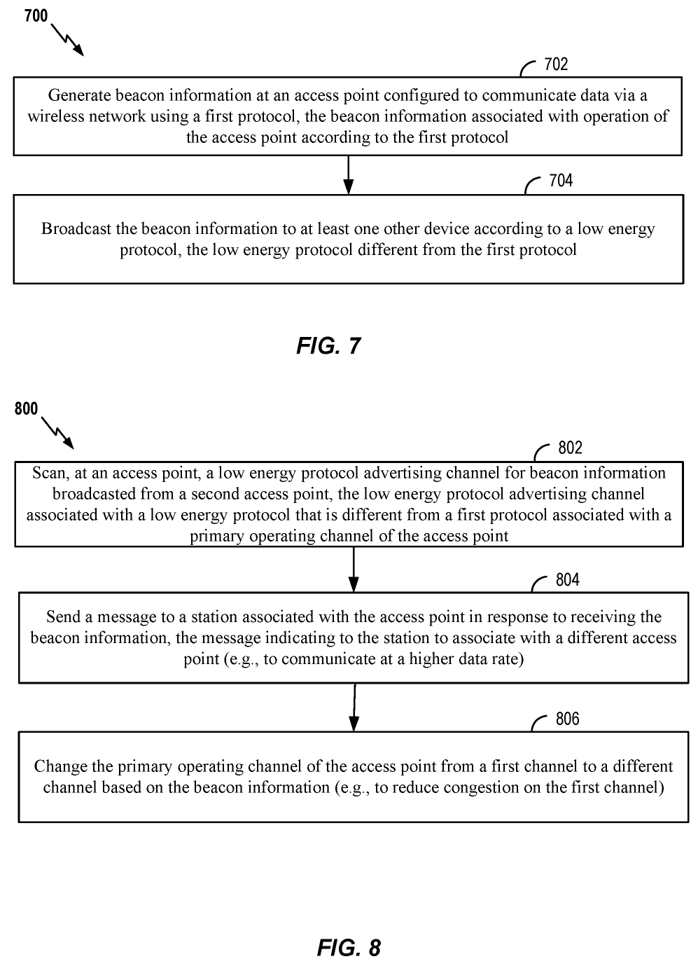

Referring to FIG. 7, a method 700 for enabling access point discovery in a wireless network is shown. In an illustrative implementation, the method 700 may be performed using the access point 102 of FIGS. 5-6.

The method 700 includes generating beacon information at an access point configured to communicate data via a wireless network using a first protocol, at 702. The beacon information may be associated with operation of the access point according to the first protocol. For example, referring to FIG. 5, the low energy protocol data generation module 110 may be configured to generate the beacon information 544 according to the low energy protocol (e.g., the BLE protocol). The beacon information 544 may include a subset of information that would be included in a “traditional” beacon. Thus, although the beacon information 544 is communicated by the access point 102 using one protocol (e.g., BLE), the beacon information may be associated with operation of the access point 102 according to another protocol (e.g., a Wi-Fi protocol). As an example, the beacon information 544 may include Wi-Fi discovery information associated with the access point 102 and one or more neighboring access points.

In one example, the beacon information includes an information element (IE) for basic service set (BSS) operation, an IE for Institute of Electronics Engineers (IEEE) 802.11k radio resource management, or a combination thereof. The first IE may indicate a primary operating channel of the access point 102, a channel width of the primary operating channel, multiple-input multiple-output (MIMO) capabilities of the access point 102, or a combination thereof. The second IE may indicate a BSS load associated with the access point 102, a BSS access delay associated with the access point 102, or a combination thereof. The BSS load corresponds to an amount of traffic in the primary operating channel, and the BSS access delay corresponds to an amount of time associated with transmitting a data packet from the access point to at least one other device.

The beacon information may be broadcasted to at least one other device according to a low energy protocol, at 704. The low energy protocol may be different from the first protocol. The first protocol may comprise an Institute of Electrical and Electronics Engineers (IEEE) 802.11 protocol, and the low energy protocol may comprise a Bluetooth® Low Energy (BLE) protocol. For example, referring to FIG. 5, the access point 102 may broadcast the beacon information 544 to the station 122 according to the BLE protocol. To illustrate, the access point 102 may send the beacon information 544 to the station 122 via the low energy protocol advertising channel 142. Although the station 122 is depicted as being within the wireless network 190 (e.g., “associated” with the access point 102), in other implementations, the station 122 may be external to the wireless network 190 (e.g., “unassociated” with the access point 102) when the beacon information 544 is received. Thus, according to the method 700, the at least one other device that receives the beacon information may comprise a station of the wireless network or a station external to the wireless network.

As another example, referring to FIG. 6, the access point 102 may broadcast the beacon information to the access point 602 according to the BLE protocol. To illustrate, the access point 102 may send the beacon information 544 to the access point 602 via the low energy protocol advertising channel 142. Although the access point 602 is depicted as being part of the same wireless network 190 as the access point 102, in other implementations, the access point 602 may be external to the wireless network 190 (e.g., may be part of a different wireless network). Thus, according to the method 700, the at least one other device that receives the beacon information may comprise a second access point of the wireless network or a second access point that is associated with a different wireless network.

The method 700 of FIG. 7 may enable out-of-band discovery of BLE-assisted access points at the station 122. For example, the station 122 may “discover” the access point 102 by tuning to the low energy protocol advertising channel 142 for the beacon information 544 instead of randomly scanning a plurality of Wi-Fi channels for beacons. Additionally, the method 700 may enable out-of-band discovery of BLE-assisted access points at the access point 602. For example, the access point 602 may receive information about neighboring access points (via the beacon information 544 sent on the low energy protocol advertising channel 142) while maintaining operations on the access point's 602 primary operating channel (e.g., the Wi-Fi channel 652 or the Wi-Fi channel 662). Thus, the access point 602 may “discover” the access point 102 and/or other neighboring access points by receiving the broadcasted beacon information 544 on the low energy protocol advertising channel 142 and without scanning Wi-Fi channels.

Referring to FIG. 8, another method 800 for enabling access point discovery in a wireless network is shown. In an illustrative implementation, the method 800 may be performed using the access point 602 of FIG. 6.

The method 800 includes scanning, at an access point, a low energy protocol advertising channel for beacon information broadcasted from a second access point, at 802. The low energy protocol advertising channel may be associated with a low energy protocol that is different from a first protocol associated with a primary operating channel of the access point. For example, referring to FIG. 6, the access point 602 may scan the low energy protocol advertising channel 142 for the beacon information 544 broadcasted from the access point 102.

The method 800 may also include sending a message to a station associated with the access point in response to receiving the beacon information, at 804. The message may indicate to the station to associate with a different access point (e.g., to communicate at a higher data rate). For example, referring to FIG. 6, if the station 622 is associated with the access point 602 and the primary operating channel of the access point 602 is the Wi-Fi channel 652, the access point 602 may send a data frame 654 to station 622. The data frame 654 may include a message that instructs the station to associate with a different access point. If the station 622 is associated with the access point 602 and the primary operating channel of the access point 602 is the Wi-Fi channel 662, the access point 602 may send a data frame 664 to the station. The data frame 664 may include a message that instructs the station to associate with a different access point.

The method 800 may also include changing the primary operating channel of the access point from a first channel to a different channel based on the beacon information (e.g., to reduce congestion on the first channel), at 806. For example, referring to FIG. 6, assume that the Wi-Fi channel 652 in the first frequency band (e.g., the 2.4 GHz frequency band) is the primary operating channel of the access point 602. If the access point 602 determines that a neighboring access point is also operating on the Wi-Fi channel 652 based on the beacon information 544, the access point 602 may change the primary operating channel of the access point 602 to a different channel.

The method 800 of FIG. 8 may enable out-of-band discovery of BLE-assisted access points at the access point 602. For example, the access point 602 may receive information about neighboring access points (via the beacon information 544 sent on the low energy protocol advertising channel 142) while maintaining operations on the access point's 602 primary operating channel (e.g., the Wi-Fi channel 652 or the Wi-Fi channel 662). Thus, the access point 602 may “discover” the access point 102 and/or other neighboring access points by receiving the broadcasted beacon information 544 on the low energy protocol advertising channel 142 and without scanning Wi-Fi channels.

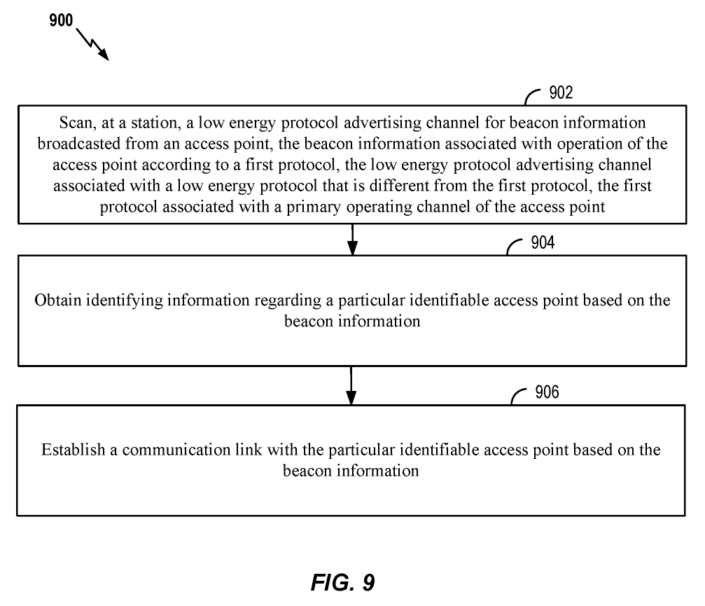

Referring to FIG. 9, another method 900 for enabling access point discovery in a wireless network is shown. In an illustrative implementation, the method 900 may be performed using the station 122 of FIG. 5.

The method 900 includes scanning, at a station, a low energy protocol advertising channel of a wireless network for beacon information broadcasted from an access point, at 902. The beacon information may be associated with operation of the access point according to a first protocol, and the low energy protocol advertising channel may be associated with a low energy protocol that is different from the first protocol. The first protocol may be associated with a primary operating channel of the access point. For example, referring to FIG. 5, the station 122 may scan the low energy protocol advertising channel 142 for the beacon information 544 broadcasted from the access point 102. To illustrate, the transceiver 128 may scan the low energy protocol advertising channel 142 to receive the beacon information 544 from the access point 102. In this example, the transceiver 128 may be a low energy protocol transceiver that is operable to receive the beacon information 544. For example, the station 122 may monitor BLE broadcasts (e.g., broadcasts of the beacon information 544) over the low energy protocol advertising channel 142. The station may tune to the low energy protocol advertising channel 142 and “look for” the beacon information 544 at regularly scheduled intervals. Thus, by tuning to the low energy protocol advertising channel 142 for the beacon information 544 instead of randomly scanning a plurality of Wi-Fi channels for beacons, the amount of time for discovering access point connectivity information may be improved (e.g., reduced).

The method 900 may include obtaining identifying information regarding a particular identifiable access point based on the beacon information, at 904. For example, referring to FIG. 5, the station 122 may obtain identifying information regarding the access point 102 or another nearby access point based on the beacon information 544. As a non-limiting example, the identifying information may include the primary operating channel of the access point 102 or another nearby access point.

The method 900 may include establishing a communication link with the particular identifiable access point based on the beacon information, at 906. For example, referring to FIG. 5, the Wi-Fi module 132 may establish a Wi-Fi communication link with the access point 102. Establishing the Wi-Fi communication link may include determining a primary operating channel of the access point 102 and transmitting an authentication frame to the access point 102 via the primary operating channel (e.g., as part of an association procedure). Establishing the communication link may further include receiving an acknowledgment frame from the access point 102.

The method 900 may also include sending a probe request to the particular identifiable access point for additional information about the particular identifiable access point. The probe request may be sent in response to receiving the beacon information 544 over the low energy protocol advertising channel 142. The method 900 may also include receiving a probe response from the particular identifiable access point. The probe response may include the additional information about the particular identifiable access point. In one example, the probe request may be sent over a BLE data channel and the probe response may be received over the BLE data channel. In another example, the probe request may be sent over an IEEE 802.11 channel and the probe response may be received over the IEEE 802.11 channel.

The method 900 of FIG. 9 may enable out-of-band discovery of BLE-assisted access points at the station 122. For example, the station 122 may “discover” the access point 102 by tuning to the low energy protocol advertising channel 142 for the beacon information 544 instead of randomly scanning a plurality of Wi-Fi channels for beacons. To illustrate, if the station 122 is “unassociated” with the access point 102, scanning the low energy protocol advertising channel 142 for the beacon information 544 may enable fast discovery of BLE-assisted access points (e.g., the access point 102) without active scanning (e.g., probing access points on a plurality of Wi-Fi channels) and without passive scanning (e.g., “listening” for beacons on a plurality of Wi-Fi channels). In some implementations, it may take seconds to find a “preferred” access point using active scanning techniques and/or passive scanning techniques. For example, it may take seconds to scan each Wi-Fi channel in the 2.4 GHz frequency band and to scan each Wi-Fi channel in the 5 GHz frequency band for beacons/probe responses.

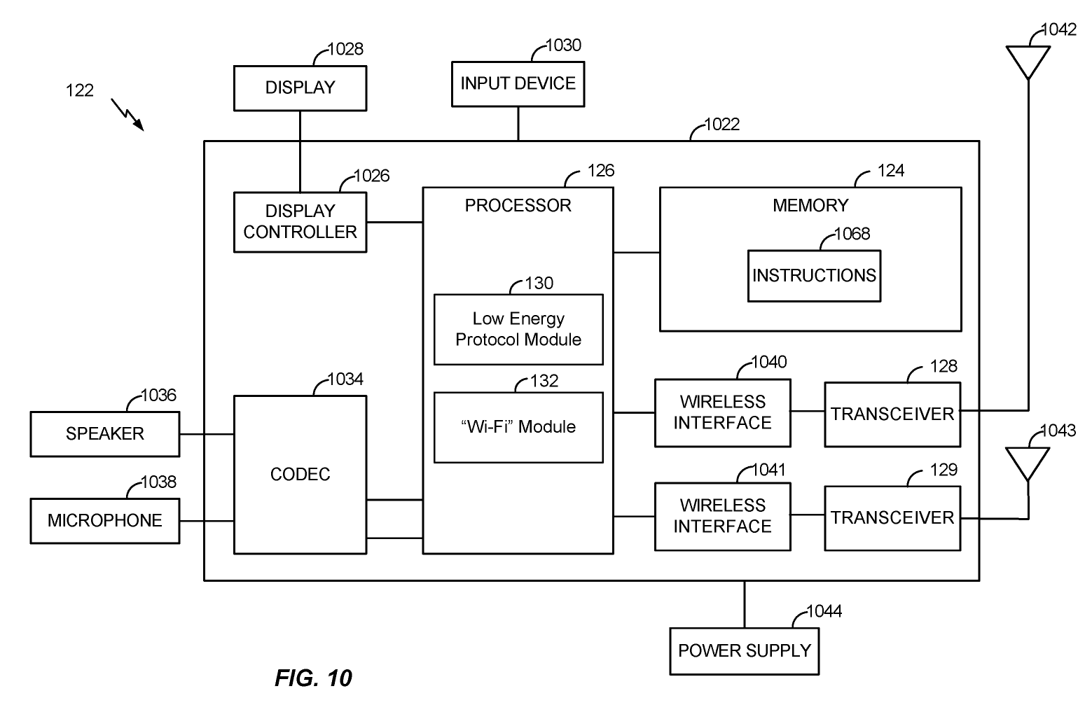

Referring to FIG. 10, a block diagram of a particular illustrative implementation of the station 122 is shown. The station 122 includes the processor 126, such as a digital signal processor, coupled to the memory 124.

The processor 126 may be configured to execute software (e.g., a program of one or more instructions 1068) stored in the memory 124. Additionally or alternatively, the processor 126 may be configured to implement one or more instructions stored in a memory of a wireless interface 1040 (e.g., an IEEE 802.11 wireless interface) and/or to implement one or more instructions stored in a memory of a wireless interface 1041 (e.g., a BLE wireless interface). The processor 126 may be configured to operate in accordance with the method 400 of FIG. 4. For example, the low energy protocol module 130 of the processor 126 may process the beacon information 144 while the station 122 is in the sleep mode and may wake up the station 122 based on the beacon information 144. To illustrate, if the TIM field 206 in FIG. 2 indicates that there is buffered downlink data for the station 122 stored at the access point 102, the processor 126 (e.g., the low energy protocol module 130) may wake up the station 122 to enable the Wi-Fi module 132 to retrieve the buffered downlink data over the Wi-Fi channel 152. As another example, if the sequence number field 208 in FIG. 2 indicates that a “critical” update to an element inside of the beacon 154 has occurred, the processor 126 (e.g., the low energy protocol module 130) may wake up the station 122 to enable the Wi-Fi module 132 to receive the beacon 154 on the Wi-Fi channel 152 and to process information associated with the update.

The processor 126 may also be configured to operate in accordance with the method 900 of FIG. 9. For example, the low energy protocol module 130 of the processor 126 may process the beacon information 144 and establish a communication link with the access point 102 of FIG. 1 based on information (e.g., identifying information) in the beacon information 144.

The wireless interface 1040 may be coupled to the processor 126 and to an antenna 1042. For example, the wireless interface 1040 may be coupled to the antenna 1042 via the transceiver 128, such that wireless data received via the antenna 1042 may be provided to the processor 126. The wireless interface 1041 may be coupled to the processor 126 and to an antenna 1043. For example, the wireless interface 1041 may be coupled to the antenna 1043 via the transceiver 129, such that wireless data (e.g., the beacon information 144 of FIG. 1) received via the antenna 1043 may be provided to the processor 126.

A coder/decoder (CODEC) 1034 can also be coupled to the processor 126. A speaker 1036 and a microphone 1038 can be coupled to the CODEC 1034. A display controller 1026 can be coupled to the processor 126 and to a display device 1028. In a particular implementation, the processor 126, the display controller 1026, the memory 124, the CODEC 1034, the wireless interface 1040, and the wireless interface 1041 are included in a system-in-package or system-on-chip device 1022. In a particular implementation, an input device 1030 and a power supply 1044 are coupled to the system-on-chip device 1022. Moreover, in a particular implementation, as illustrated in FIG. 10, the display device 1028, the input device 1030, the speaker 1036, the microphone 1038, the antenna 1042, and the power supply 1044 are external to the system-on-chip device 1022. However, each of the display device 1028, the input device 1030, the speaker 1036, the microphone 1038, the antenna 1042, the antenna 1043, and the power supply 1044 can be coupled to one or more components of the system-on-chip device 1022, such as one or more interfaces or controllers.

In conjunction with the described implementations, a first apparatus includes means for generating beacon information at an access point of a wireless network. The access point may be configured to communicate downlink data to a station of the wireless network according to a first protocol. For example, the means for generating the beacon information may include the processor 106 of FIG. 1, the low energy protocol data generation module 110 of FIG. 1, a processor programmed to execute instructions, one or more other devices, circuits, modules, instructions, or any combination thereof.

The first apparatus may also include means for sending the beacon information to the station while the station is in a sleep mode according to a low energy protocol that is different from the first protocol. For example, the means for sending the beacon information may include the transceiver 108 of FIG. 1, one or more other devices, circuits, modules, or any combination thereof.

In conjunction with the described implementations, a second apparatus includes means for receiving beacon information at a station of a wireless network from an access point of the wireless network. The beacon information may be received according to a low energy protocol while the station is in a sleep mode. For example, the means for receiving the beacon information may include the transceiver 128 of FIGS. 1 and 10, the antenna 1043 of FIG. 10, the wireless interface 1041 of FIG. 10, one or more other devices, circuits, modules, or any combination thereof.

The second apparatus may also include means for entering into an awake mode to communicate with the access point based on the beacon information according to a first protocol that is different form the low energy protocol. For example, the means for entering into the awake mode may include the low energy protocol module 130 of FIGS. 1 and 10, the Wi-Fi module 132 of FIGS. 1 and 10, the processor 126 of FIGS. 1 and 10, a processor programmed to execute instructions, one or more other devices, circuits, modules, instructions, or any combination thereof.

In conjunction with the described implementations, a third apparatus includes means for generating beacon information at an access point configured to communicate data via a wireless network using a first protocol. The beacon information may be associated with operation of the access point according to the first protocol. For example, the means for generating the beacon information may include the processor 106 of FIG. 1, the low energy protocol data generation module 110 of FIG. 1, a processor programmed to execute instructions, one or more other devices, circuits, modules, instructions, or any combination thereof.

The third apparatus may also include means for broadcasting the beacon information to at least one other device according to a low energy protocol. The low energy protocol may be different from the first protocol. For example, the means for broadcasting the beacon information may include the transceiver 108 of FIG. 1, one or more other devices, circuits, modules, or any combination thereof.

In conjunction with the described implementations, a fourth apparatus includes means for scanning a low energy protocol advertising channel for beacon information at an access point. The beacon information may be broadcasted from a second access point, and the low energy protocol advertising channel may be associated with a low energy protocol that is different from a first protocol associated with a primary operating channel of the access point. For example, the means for scanning may include the transceiver of the access point 602 of FIG. 6, one or more other devices, circuits, modules, or any combination thereof.

The fourth apparatus may also include means for changing the primary operating channel of the access point to a different channel based on the beacon information. For example, the means for changing the primary operating channel may include the processor of the access point 602 of FIG. 6, one or more other devices, circuits, modules, or any combination thereof.

In conjunction with the described implementations, a fifth apparatus includes means for scanning a low energy protocol advertising channel for beacon information at a station. The beacon information may be broadcasted from an access point, and the beacon information may be associated with operation of the access point according to a first protocol. The low energy protocol advertising channel may be associated with a low energy protocol that is different from the first protocol, and the first protocol may be associated with a primary operating channel of the access point. For example, the means for scanning may include the transceiver 128, the wireless interface 1040, the antenna 1042, one or more other devices, circuits, modules, instructions, or any combination thereof.

The fifth apparatus may also include means for obtaining identifying information regarding a particular identifiable access point based on the beacon information. For example, the means for obtaining the identifying information may include the low energy protocol module 130, the Wi-Fi module 132, the processor 126, a processor programmed to execute instructions, one or more other devices, circuits, modules, instructions, or any combination thereof.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method for enabling access point discovery in a wireless network, the method comprising:
scanning, at an access point, a low energy protocol advertising channel for beacon information broadcasted from a second access point, the low energy protocol advertising channel associated with a low energy protocol that is different from a first protocol associated with a primary operating channel of the access point; and
receiving the beacon information at the access point via the low energy protocol advertising channel.

2. The method of claim 1, wherein the first protocol comprises an Institute of Electrical and Electronics Engineers (IEEE) 802.11 protocol, and wherein the low energy protocol comprises a Bluetooth Low Energy (BLE) protocol.

3. The method of claim 1, wherein the low energy protocol advertising channel is included in a 2.4 gigahertz (GHz) frequency band, and wherein the low energy protocol advertising channel is a non-overlapping channel with respect to at least one other channel in the 2.4 GHz frequency band.

4. The method of claim 3, wherein the at least one other channel includes the primary operating channel, the at least one other channel used to communicate according to the first protocol.

5. The method of claim 1, further comprising changing the primary operating channel for the first protocol of the access point from a first channel to a different channel based on the beacon information to reduce congestion on the first channel.

6. The method of claim 1, further comprising changing a primary operating band for the first protocol of the access point from a first frequency band to a second frequency band based on the beacon information to reduce congestion on the first frequency band.

7. The method of claim 1, further comprising sending a message to a station associated with the access point in response to receiving the beacon information, the message indicating to the station to associate with a different access point to communicate at a higher data rate.

8. An apparatus comprising:
a processor; and
a memory coupled to the processor and storing instructions that, when executed by the processor, cause the processor to perform operations comprising:
scanning, at an access point, a low energy protocol advertising channel for beacon information broadcasted from a second access point, the low energy protocol advertising channel associated with a low energy protocol that is different from a first protocol associated with a primary operating channel of the access point; and
receiving the beacon information at the access point via the low energy protocol advertising channel.

9. The apparatus of claim 8, further comprising:
a first transceiver configured to communicate according to the low energy protocol; and
a second transceiver configured to communicate according to the first protocol.

10. The apparatus of claim 8, wherein the first protocol comprises an Institute of Electrical and Electronics Engineers (IEEE) 802.11 protocol, and wherein the low energy protocol comprises a Bluetooth Low Energy (BLE) protocol.

11. The apparatus of claim 8, wherein the low energy protocol advertising channel is included in a 2.4 gigahertz (GHz) frequency band, and wherein the low energy protocol advertising channel is a non-overlapping channel with respect to at least one other channel in the 2.4 GHz frequency band.

12. The apparatus of claim 11, wherein the at least one other channel includes the primary operating channel, the at least one other channel used to communicate according to the first protocol.

13. The apparatus of claim 8, wherein the operations further comprise changing the primary operating channel for the first protocol of the access point from a first channel to a different channel based on the beacon information to reduce congestion on the first channel.

14. The apparatus of claim 8, wherein the operations further comprise changing a primary operating band for the first protocol of the access point from a first frequency band to a second frequency band based on the beacon information to reduce congestion on the first frequency band.

15. The apparatus of claim 8, wherein the operations further comprise sending a message to a station associated with the access point in response to receiving the beacon information, the message indicating to the station to associate with a different access point to communicate at a higher data rate.

16. The apparatus of claim 8, wherein the processor and the memory are integrated in a mobile device.

17. A method comprising:
scanning, at a station, a low energy protocol advertising channel for beacon information broadcasted from an access point, the beacon information associated with operation of the access point according to a first protocol that is associated with a primary operating channel of the access point, the low energy protocol advertising channel associated with a low energy protocol that is different from the first protocol; and
receiving the beacon information at the station via the low energy protocol advertising channel.

18. The method of claim 17, wherein the first protocol comprises an Institute of Electrical and Electronics Engineers (IEEE) 802.11 protocol, and wherein the low energy protocol comprises a Bluetooth Low Energy (BLE) protocol.

19. The method of claim 17, further comprising obtaining identifying information regarding a particular access point based on the beacon information.

20. The method of claim 19, wherein the particular access point comprises the access point.

21. The method of claim 19, wherein the particular access point is different from the access point.

22. The method of claim 19, further comprising initiating a communication link with the particular access point based on the beacon information.

23. The method of claim 22, wherein initiating the communication link with the particular access point comprises:
transmitting an association frame to the particular access point via an operating channel of the particular access point according to the first protocol; and
receiving an acknowledgment frame from the particular access point.

24. An apparatus comprising:
a processor; and
a memory coupled to the processor and storing instructions that, when executed by the processor, cause the processor to perform operations comprising:
scanning, at a station, a low energy protocol advertising channel for beacon information broadcasted from an access point, the low energy protocol advertising channel associated with a low energy protocol that is different from a first protocol associated with a primary operating channel of the access point; and
receiving the beacon information at the station via the low energy protocol advertising channel.

25. The apparatus of claim 24, further comprising:
a first transceiver configured to communicate according to the low energy protocol; and
a second transceiver configured to communicate according to the first protocol.

26. The apparatus of claim 24, wherein the operations further comprise obtaining identifying information regarding a particular access point based on the beacon information.

27. The apparatus of claim 26, wherein the particular access point is different from the access point.

28. The apparatus of claim 26, wherein the operations further comprise initiating a communication link with the particular access point based on the beacon information.

29. The apparatus of claim 28, wherein initiating the communication link with the particular access point comprises:
transmitting an association frame to the particular access point via an operating channel of the particular access point according to the first protocol; and
receiving an acknowledgment frame from the particular access point.

30. The apparatus of claim 24, wherein the processor and the memory are integrated in a mobile device.
